(19) United States
(12) Patent Application Publication
(10) Pub. No.: US 2022/0167754 A1
(43) Pub. Date: Jun. 2, 2022

(54) SLEEPING EQUIPMENT

(71) Applicants: TOYOTA JIDOSHA KABUSHIKI KAISHA, Aichi-ken (JP); TOYOTA BOSHOKU KABUSHIKI KAISHA, Aichi-ken (JP)

(72) Inventors: Gen FUKUYAMA, Nagoya-shi (JP); Mikio INOUE, Nagoya-shi (JP); Reiko YAMAMATO, Anjyo-shi (JP); Hayato WAKATSUKI, Anjo-shi (JP); Tsutomu HANASE, Kariya-shi (JP); Shigeki TANAKA, Nagoya-shi (JP)

(21) Appl. No.: 17/523,925

(22) Filed: Nov. 11, 2021

(30) Foreign Application Priority Data
Nov. 30, 2020 (JP) 2020-198991

(51) Int. Cl. A47C 27/08; A61G 7/002; A61G 7/057

(52) U.S. Cl. CPC A47C 27/08; A61G 7/05769; A61G 7/002

(57) ABSTRACT

Sleeping equipment includes: a mat body including a middle support portion configured to support buttocks of a user, an upper support portion configured to support a back and head of the user, and a lower support portion configured to support thighs of the user; a movable mechanism configured to switch the mat body between a bed mode in which the mat body has a flat shape in which the middle support portion, the upper support portion, and the lower support portion are continuous with each other and a comfortable mode in which the upper support portion and the lower support portion are tilted upward with respect to the middle support portion; and a lower back pressing mechanism configured to cause a part of the upper support portion corresponding to a lower back of the user in the comfortable mode to bulge out toward the user.

### CROSS-REFERENCE TO RELATED APPLICATION

This application claims priority to Japanese Patent Application No. 2020-198991 filed on Nov. 30, 2020, incorporated herein by reference in its entirety.

### BACKGROUND

### 1. Technical Field

The present disclosure relates to sleeping equipment.

### 2. Description of Related Art

Japanese Unexamined Patent Application Publication No. 2004-229966 (JP 2004-229966 A) discloses a structure in which a plurality of air cells is arranged in the longitudinal direction of an air mat. In the structure disclosed in JP 2004-229966 A, the body pressure distribution effect is enhanced by fixing both longitudinal ends of a mattress to the air cells.

### SUMMARY

Massage chairs that can exert the stretching effect by pressing the lower back etc. of a user are known in the art. A possible example of sleeping equipment that can exert the stretching effect is sleeping equipment configured to press the lower back etc. of the user by inflating the air cells of JP 2004-229966 A. However, since the position of the lower back varies depending on the physique of the user, there is room for improvement to effectively exert the stretching effect.

The present disclosure provides sleeping equipment that can effectively exert the stretching effect regardless of the physique of the user.

The sleeping equipment according to one aspect of the present disclosure includes: a mat body including a middle support portion configured to support buttocks of a user, an upper support portion configured to support a back and head of the user, and a lower support portion configured to support thighs of the user; a movable mechanism configured to switch the mat body between a bed mode and a comfortable mode, the bed mode being a mode in which the mat body has a flat shape with the middle support portion, the upper support portion, and the lower support portion being continuous with each other, and the comfortable mode being a mode in which the upper support portion and the lower support portion are tilted upward with respect to the middle support portion; and a lower back pressing mechanism provided in a part of the upper support portion corresponding to a lower back of the user in the comfortable mode, the lower back pressing mechanism being configured to bulge out toward the user in the comfortable mode.

According to the above aspect, the mat body includes the middle support portion, the upper support portion, and the lower support portion. The mat body is configured to be switched between the bed mode and the comfortable mode by the movable mechanism. In the bed mode, the mat body has a flat shape in which the middle support portion, the upper support portion, and the lower support portion are continuous with each other. On the other hand, in the comfortable mode, the upper support portion and the lower support portion are tilted upward with respect to the middle support portion. The user can thus change from a sleeping posture to a comfortable posture by operating the movable mechanism.

The part of the upper support portion corresponding to the lower back of the user in the comfortable mode is caused to bulge out toward the user by the lower back pressing mechanism. In the comfortable mode, the upper support portion and the lower support portion are tilted upward with respect to the middle support portion. Accordingly, in the comfortable mode, the buttocks (hip point) are supported by the middle support portion regardless of the physique of the user. Since the lower back is relatively close to the buttocks, the lower back falls within a certain range regardless of the physique of the user. The lower back can therefore be pressed by operating the lower back pressing mechanism.

In the above aspect, the sleeping equipment may further include a spine pressing mechanism provided in a middle in a lateral direction of the upper support portion and configured to bulge out toward the user.

According to the above configuration, the user's chest can be expanded by pressing the user's spine with the spine pressing mechanism. This allows the user to take in a large amount of air, and breathing can thus be facilitated.

In the above aspect, the sleeping equipment may further include a biological sensor configured to detect biological information of the user. The spine pressing mechanism may be configured to operate according to a breathing pattern of the user based on the biological information from the biological sensor.

According to the above configuration, the spine pressing mechanism operates according to the breathing pattern of the user. Breathing of the user can thus be effectively facilitated.

In the above aspect, the lower back pressing mechanism and the spine pressing mechanism may be configured to operate when determination that the user is in a state of stress is made based on the biological information from the biological sensor.

According to the above configuration, when the user is in a state of stress, the lower back pressing mechanism and the spine pressing mechanism are operated to stretch the body of the user. The stress can thus be reduced.

In the above aspect, the lower back pressing mechanism and the spine pressing mechanism may be configured to operate when determination that the user has woken up from sleep is made based on the biological information from the biological sensor.

According to the above configuration, the user can take a large amount of air into his or her body when he or she wakes up from sleep. The user can thus wakes up comfortably.

In the above aspect, the lower back pressing mechanism may include a lower back bladder disposed inside the upper support portion, and an air supply unit configured to supply air into the lower back bladder.

According to the above configuration, air is supplied from the air supply unit into the lower back bladder (air bag) to inflate the lower back bladder, thereby pressing the lower back of the user. The lower back of the user can thus be pressed with a simple structure. Moreover, reduction in weight can be achieved as compared to a structure that mechanically presses the lower back.

According to the above aspect of the present disclosure, the stretching effect can be effectively exerted regardless of the physique of the user.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a schematic side view of sleeping equipment according to an embodiment as viewed in the lateral direction of the sleeping equipment, illustrating a comfortable mode;

FIG. 2 is a schematic side view of the sleeping equipment with a lower back pressing mechanism bulging out from the state of FIG. 1;

FIG. 3 is a schematic side view of the sleeping equipment according to the embodiment as viewed in the lateral direction of the sleeping equipment, illustrating a bed mode;

FIG. 4 is a schematic plan view of the sleeping equipment according to the embodiment as viewed from above;

FIG. 5 is a block diagram illustrating a hardware configuration of the sleeping equipment according to the embodiment;

FIG. 6 is a block diagram illustrating functional configurations of the sleeping equipment according to the embodiment; and

FIG. 7 is a schematic side view of sleeping equipment according to a modification as viewed in the lateral direction of the sleeping equipment, illustrating a comfortable mode.

### DETAILED DESCRIPTION OF EMBODIMENTS

### First Embodiment

Sleeping equipment 10 according to a first embodiment will be described with reference to the drawings. Arrows FR, UP, and RH shown as appropriate in the drawings indicate the forward direction, upward direction, and right side in the lateral direction of the sleeping equipment 10, respectively. Hereinafter, when description is given by simply using the terms indicating the longitudinal, vertical, and lateral directions, it means front and rear in the longitudinal direction of the sleeping equipment 10, up and down in the vertical direction of the sleeping equipment 10, and right and left in the lateral direction of the sleeping equipment 10. The forward direction of the sleeping equipment 10 is a direction in the horizontal direction from head toward legs when the user uses the sleeping equipment 10.

### Overall Configuration

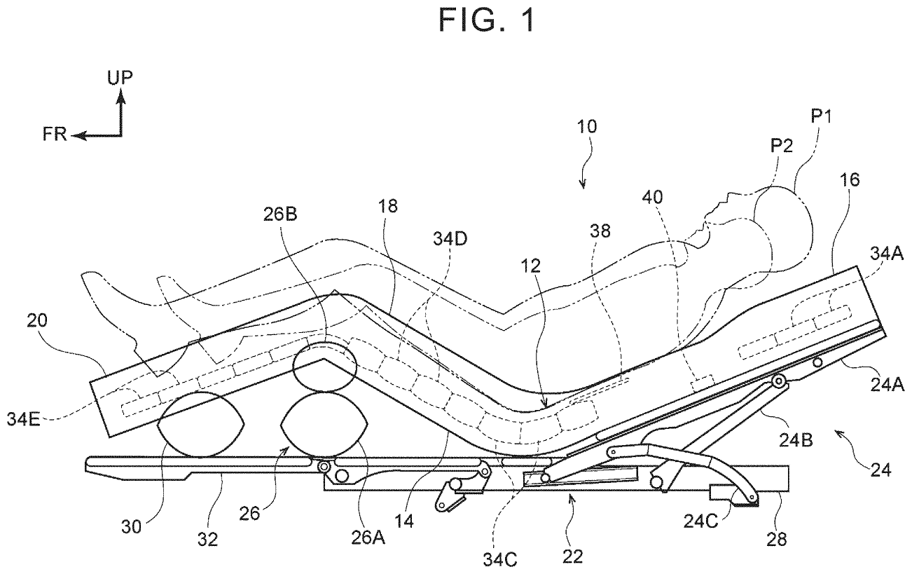

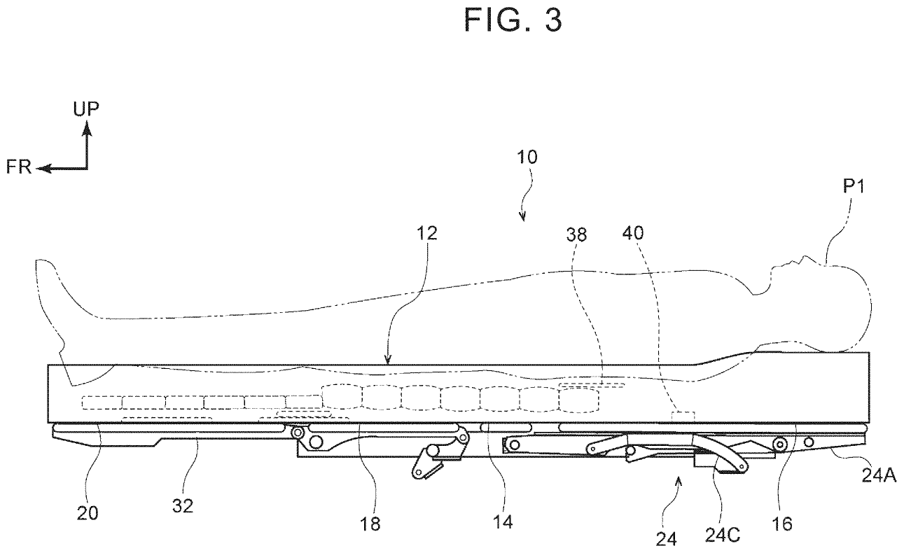

As shown in FIGS. 1 to 3, the sleeping equipment 10 of the present embodiment includes a mat body 12. The mat body 12 is configured to switch between a comfortable mode shown in FIG. 1 and a bed mode shown in FIG. 3. In the comfortable mode, a user P1 can sit in a comfortable posture on the mat body 12. In the bed mode, the user P1 lying on his or her back can be supported by the mat body 12. A user P2 smaller than the user P1 is also shown in FIG. 1. For example, the user P1 is a man with an average body type, and the user P2 is a small woman.

The mat body 12 includes a middle support portion 14, an upper support portion 16, a lower support portion 18, and a leg support portion 20. The middle support portion 14 is provided in the middle part in the longitudinal direction of the mat body 12, and is configured to support the buttocks of the user P1.

The upper support portion 16 is provided behind the middle support portion 14 continuously with the middle support portion 14. In the bed mode shown in FIG. 3, the upper support portion 16 extends substantially linearly in the horizontal direction. The upper support portion 16 is configured to support the back and head of the user P1.

The lower support portion 18 is provided in front of the middle support portion 14 continuously with the middle support portion 14. In the bed mode shown in FIG. 3, the lower support portion 18 extends substantially linearly in the horizontal direction. The lower support portion 18 is configured to support the thighs of the user P1.

The leg support portion 20 is provided in front of the lower support portion 18 continuously with the lower support portion 18. In the bed mode shown in FIG. 3, the leg support portion 20 extends substantially linearly in the horizontal direction. The leg support portion 20 is configured to support the legs of the user P1. As described above, in the bed mode, the mat body 12 has a flat shape in which the middle support portion 14, the upper support portion 16, the lower support portion 18, and the leg support portion 20 are continuous with each other.

As shown in FIG. 1, in the comfortable mode, the middle support portion 14 of the mat body 12 is bent in a substantially V shape with its vertex pointing downward as viewed in the lateral direction. In the comfortable mode shown in FIG. 1, the upper support portion 16 is tilted with its rear end higher than its front end on the middle support portion 14 side.

In the comfortable mode shown in FIG. 1, the lower support portion 18 is tilted with its front end higher than its rear end on the middle support portion 14 side. Accordingly, in the comfortable mode, the mat body 12 has a substantially V-shape in which the upper support portion 16, the middle support portion 14, and the lower support portion 18 are continuous with each other with the middle support portion 14 located at the lowest position as viewed in the lateral direction.

In the comfortable mode shown in FIG. 1, the leg support portion 20 is tilted downward with its front end lower than its rear end located at the front end of the lower support portion 18. Accordingly, the lower support portion 18 and the leg support portion 20 are bent in a substantially V shape with its vertex pointing upward as viewed in the lateral direction.

A movable mechanism 22 for switching the mat body 12 between the comfortable mode and the bed mode is provided below the mat body 12. The movable mechanism 22 includes a link mechanism 24, a lifting bladder 26, and a support base 28.

The support base 28 is a substantially plate-like frame member extending in the horizontal direction such that its thickness direction matches the vertical direction. The support base 28 is placed on a floor surface, not shown, and supports the mat body 12 from below. The link mechanism 24 is provided on the rear part of the support base 28. The link mechanism 24 includes a first link 24A, a second link 24B, and a third link 24C.

The first link 24A is attached to the lower surface of the upper support portion 16 of the mat body 12. One end of the first link 24A is rotatably connected to the support base 28. The second link 24B has an elongated shape. One end of the second link 24B is rotatably connected to the rear part of the first link 24A, and the other end of the second link 24B is rotatably connected to the support base 28.

The third link 24C has a substantially arc shape as viewed in the lateral direction. One end of the third link 24C is rotatably connected to the front part of the first link 24A, and the other end of the third link 24C is rotatably connected to the support base 28.

A motor, not shown, is provided at the connection portion between the second link 24B and the support base 28. The second link 24B is configured to rotate about its one end when the motor is operated. Although a pair of right and left first links 24A, a pair of right and left second links 24B, and a pair of right and left third links 24C are provided, only the left side is shown in FIGS. 1 to 3.

The lifting bladder 26 includes a lower bladder 26A and an upper bladder 26B. The lower bladder 26A and the upper bladder 26B are arranged between the support base 28 and the mat body 12. Specifically, the lower bladder 26A and the upper bladder 26B are located at the connection portion between the lower support portion 18 and the leg support portion 20 of the mat body 12.

The lower bladder 26A is attached to the support base 28. The upper bladder 26B is attached to the upper surface of the lower bladder 26A, and the internal space of the upper bladder 26B communicates with the internal space of the lower bladder 26A. An air supply unit, not shown, is configured to supply air into the lower bladder 26A. As air is supplied into the lower bladder 26A, the lower bladder 26A and the upper bladder 26B inflate and lift the connection portion between the lower support portion 18 and the leg support portion 20.

A leg bladder 30 is provided in front of the lifting bladder 26. The leg bladder 30 is attached to a rotating frame 32 that will be described later. The leg bladder 30 is configured to inflate as air is supplied into the leg bladder 30, and thus support the front part of the leg support portion 20 in a tilted state.

The rotating frame 32 is rotatably attached to the front end of the support base 28. The rotating frame 32 is provided with a lock mechanism, not shown. The rotating frame 32 is locked at a position where the rotating frame 32 is aligned with the support base 28. When unlocked, the rotating frame 32 is rotatable downward with respect to the support base 28. For example, in the case where the floor surface with the support base 28 placed thereon has a step and there is a space under the rotating frame 32, the front end of the rotating frame 32 is located below the support base 28 when the rotating frame 32 is rotated downward. When the lifting bladder 26 and the leg bladder 30 are deflated in this state, the leg support portion 20 moves downward and the mat body 12 turns into the shape of a chair.

### Support Bladder

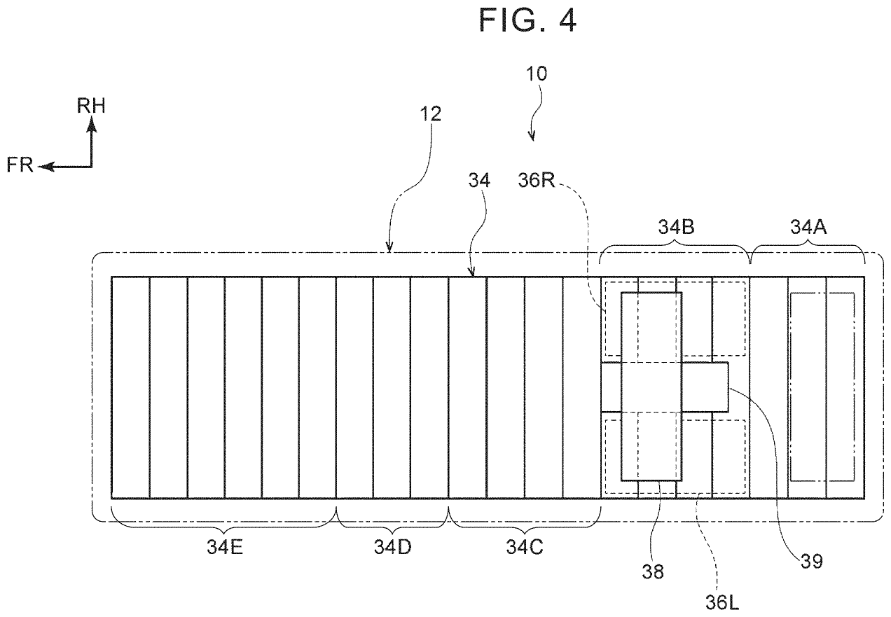

As shown in FIG. 4, a support bladder 34 is disposed inside the mat body 12. The support bladder 34 includes a support bladder 34A, a support bladder 34B, a support bladder 34C, a support bladder 34D, and a support bladder 34E.

The support bladder 34A is provided in the rear end part of the mat body 12 and is composed of three air bags connected together in the longitudinal direction. The air bags are long in the lateral direction. The support bladder 34A is disposed inside the upper support portion 16 at a position corresponding to the head of the user P1 in the comfortable posture (see FIG. 1).

The support bladder 34B is provided in front of the support bladder 34A and is composed of four air bags connected together in the longitudinal direction. The air bags are long in the lateral direction. The support bladder 34B is disposed inside the upper support portion 16 at a position corresponding to the back of the user P1 in the comfortable posture.

The support bladder 34C is provided in front of the support bladder 34B and is composed of four air bags connected together in the longitudinal direction. The air bags are long in the lateral direction. The support bladder 34C is disposed inside the middle support portion 14 at a position corresponding to the buttocks of the user P1 in the comfortable posture (see FIG. 1).

The support bladder 34D is provided in front of the support bladder 34C and is composed of three air bags connected together in the longitudinal direction. The air bags are long in the lateral direction. The support bladder 34D is disposed inside the lower support portion 18 at a position corresponding to the thighs of the user P1 in the comfortable posture (see FIG. 1).

The support bladder 34E is provided in front of the support bladder 34D and is composed of six air bags connected together in the longitudinal direction. The air bags are long in the lateral direction. The support bladder 34E is disposed inside the leg support portion 20 at a position corresponding to the legs of the user P1 in the comfortable posture (see FIG. 1).

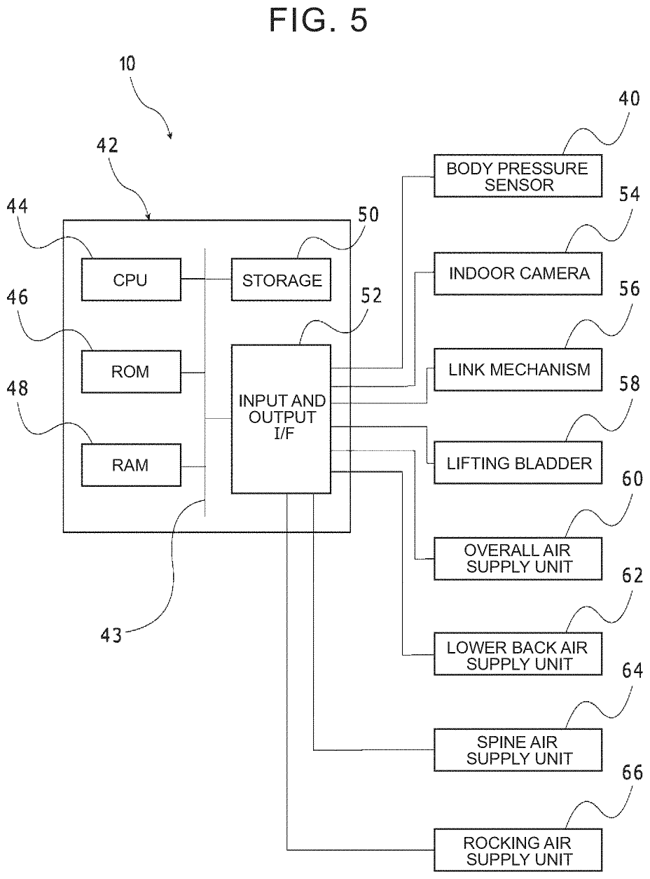

As described above, the support bladder 34 is provided from the front end to rear end of the mat body 12, and is configured to inflate as air is supplied from an overall air supply unit 60 shown in FIG. 5 into the support bladder 34. The number of air bags of the support bladder 34 is not limited.

### Rocking Bladder

A right rocking bladder 36R and a left rocking bladder 36L are provided on the lower surface side of the support bladder 34B. The right rocking bladder 36R is located in the right side with respect to the center in the lateral direction of the upper support portion 16. The left rocking bladder 36L is located in the left side with respect to the center in the lateral direction of the upper support portion 16.

The right rocking bladder 36R and the left rocking bladder 36L are configured to inflate as air is supplied from a rocking air supply unit 66 shown in FIG. 5 into the right rocking bladder 36R and the left rocking bladder 36L. The right side of the upper support portion 16 is lifted as air is supplied from the rocking air supply unit 66 into the right rocking bladder 36R. The left side of the upper support portion 16 is lifted as air is supplied from the rocking air supply unit 66 into the left rocking bladder 36L. The right rocking bladder 36R and the left rocking bladder 36L are controlled so as to operate under a predetermined condition and alternately and repeatedly inflate and deflate.

For example, the right rocking bladder 36R and the left rocking bladder 36L alternately and repeatedly inflate and deflate on the condition that the user P1, P2 has fallen asleep. The upper support portion 16 is thus rocked side to side, so that the part of the upper support portion 16 on which the body pressure of the user P1, P2 acts changes periodically. As a result, blood circulation of the user P1, P2 is facilitated, and the state of sleep can be satisfactorily maintained without the user P1, P2 turning over.

### Lower Back Bladder

A lower back bladder 38 that forms a lower back pressing mechanism is provided on the upper surface side of the support bladder 34B. The lower back bladder 38 has a substantially rectangular shape that is long in the lateral direction as viewed in plan and that is wider in the longitudinal direction than the air bags forming the upper support portion 16.

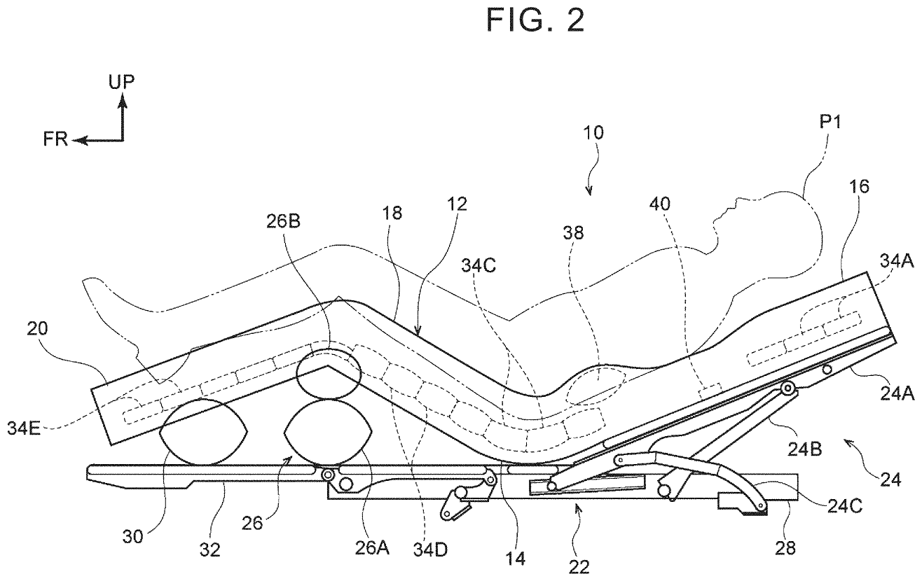

As shown in FIG. 1, the lower back bladder 38 is disposed inside a part of the upper support portion 16 corresponding to the lower back of the user P1, P2 in the comfortable mode. The lower back bladder 38 is configured to inflate as air is supplied from a lower back air supply unit 62 shown in FIG. 5 into the lower back bladder 38. As shown in FIG. 2, the part of the upper support portion 16 corresponding to the lower back bulges out toward the user P1, P2 as the lower back bladder 38 inflates. The lower back of the user P1, P2 is pressed as the lower back bladder 38 inflates.

### Spine Bladder

As shown in FIG. 4, a spine bladder 39 is provided between the support bladder 34B and the lower back bladder 38. The spine bladder 39 has a substantially rectangular shape that is long in the longitudinal direction as viewed in plan, and is disposed so as to cross the lower back bladder 38.

The spine bladder 39 is located in the middle in the lateral direction of the upper support portion 16, and extends along the spine, i.e., backbone, of the user P1, P2 in the comfortable posture. The spine bladder 39 is configured to inflate as air is supplied from a spine air supply unit 64 shown in FIG. 5 into the spine bladder 39. A part of the upper support portion 16 corresponding to the spine bulges out toward the user P1, P2 as the spine bladder 39 inflates. The spine of the user P1, P2 is thus pressed as the spine bladder 39 inflates.

As shown in FIG. 1, a body pressure sensor 40 is provided in the upper support portion 16. The body pressure sensor 40 is a biological sensor. The body pressure sensor 40 is disposed at a position corresponding to the heart of the user P1, P2, and is configured to detect the heartbeat of the user P1, P2. The breathing cycle of the user P1, P2 can be obtained by detecting changes in pressure during breathing of the user P1, P2 with the body pressure sensor 40.

### Hardware Configuration of Sleeping Equipment 10

FIG. 5 is a block diagram illustrating a hardware configuration of the sleeping equipment 10. As shown in FIG. 5, the sleeping equipment 10 includes a control unit 42. The control unit 42 includes a central processing unit (CPU) (processor) 44, a read only memory (ROM) 46, a random access memory (RAM) 48, a storage 50, and an input and output interface 52. These configurations are connected via a bus 43 so that they can communicate with each other.

The CPU 44 is a central arithmetic processing unit. The CPU 44 executes various programs and controls each unit. That is, the CPU 44 reads a program from the ROM 46 or the storage 50 and executes the program using the RAM 48 as a work area. The CPU 44 controls the above configurations and performs various arithmetic processes according to the programs stored in the ROM 46 or the storage 50.

The ROM 46 stores various programs and various data. The RAM 48 serves as a work area and temporarily stores a program or data. The storage 50 is a non-transitory recording medium that is composed of a hard disk drive (HDD) or a solid state drive (SSD) and that stores various programs including an operating system and various data. In the present embodiment, the ROM 46 or the storage 50 stores programs for performing a bladder control process, various data, etc.

The input and output interface 52 is electrically connected to the body pressure sensor 40, an indoor camera 54 that is a biological sensor, a link mechanism 56, a lifting bladder 58, the overall air supply unit 60, the lower back air supply unit 62, the spine air supply unit 64, and the rocking air supply unit 66. The body pressure sensor 40 detects changes in pressure due to the heartbeat and breathing of the user P1, P2 and sends the detected changes in pressure to the control unit 42.

The indoor camera 54 is mounted in a vehicle cabin and is oriented to the user P1, P2 sitting on the sleeping equipment 10. In the present embodiment, as an example, the indoor camera 54 is configured to capture an image of the face of the user P1, P2 and send the captured data to the control unit 42.

### Functional Configurations of Sleeping Equipment 10

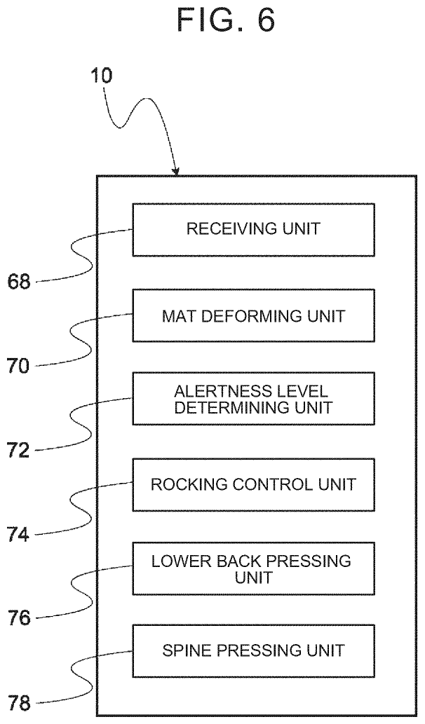

The sleeping equipment 10 implements various functions by using the above hardware resources. Functional configurations that are implemented by the sleeping equipment 10 will be described with reference to FIG. 6.

As shown in FIG. 6, the sleeping equipment 10 includes as functional configurations a receiving unit 68, a mat deforming unit 70, an alertness level determining unit 72, a rocking control unit 74, a lower back pressing unit 76, and a spine pressing unit 78. Each functional configuration is implemented by the CPU 44 reading and executing a program stored in the ROM 46 or the storage 50.

The receiving unit 68 receives signals sent from the body pressure sensor 40, the indoor camera 54, etc. The mat deforming unit 70 switches the mat body 12 between the comfortable mode and the bed mode by operating the movable mechanism 22. For example, the mat deforming unit 70 may operate the movable mechanism 22 by accepting an operation from the user P1, P2. Alternatively, the mat deforming unit 70 may switch the mat body 12 from the comfortable mode to the bed mode by operating the movable mechanism 22 when the user P1, P2 has fallen asleep. The mat deforming unit 70 may switch the mat body 12 from the bed mode to the comfortable mode by operating the movable mechanism 22 when the user P1, P2 has woken up.

The alertness level determining unit 72 determines the alertness level of the user P1, P2. Specifically, the alertness level determining unit 72 determines the alertness level of the user P1, P2 based on the information received from the body pressure sensor 40 and the indoor camera 54. For example, the alertness level determining unit 72 may determine that the user P1, P2 has fallen asleep when the alertness level determining unit 72 detects from the signal received from the indoor camera 54 that the user P1, P2 has closed his or her eyes for a predetermined time or longer. The alertness level determining unit 72 may determine that the user P1, P2 has woken up when he or she opens his or her eyes from sleep.

The alertness level determining unit 72 may acquire time series data on heart rate variability from the signal received from the body pressure sensor 40, and may determine that the user P1, P2 is asleep when sympathetic activity and heart rate have decreased based on the acquired time series data on heart rate variability. The alertness level determining unit 72 may determine that the user P1, P2 is awake when sympathetic activity has increased and parasympathetic activity has decreased. In the present embodiment, the alertness level of the user P1, P2 is determined based on both the face image data of the user P1, P2 acquired by the indoor camera 54 and the heartbeat data of the user P1, P2 acquired by the body pressure sensor 40.

The rocking control unit 74 operates the rocking air supply unit 66 when the alertness level determining unit 72 determines that the user P1, P2 has fallen asleep. When the rocking air supply unit 66 is operated by the rocking control unit 74, the right rocking bladder 36R and the left rocking bladder 36L alternately and repeatedly inflate and deflate. For example, the rocking control unit 74 alternately inflates and deflates the right rocking bladder 36R and the left rocking bladder 36L every 90 minutes.

The lower back pressing unit 76 operates the lower back air supply unit 62 when a predetermined condition is satisfied. The lower back pressing unit 76 of the present embodiment operates the lower back air supply unit 62 when the mat body 12 is in the comfortable mode. When it is determined based on the signals of the body pressure sensor 40 and the indoor camera 54 received by the receiving unit 68 that the user P1, P2 is in a state of stress, the lower back pressing unit 76 operates the lower back air supply unit 62 to inflate the lower back bladder 38. For example, the state of stress of the user P1, P2 is estimated from the time series data on heart rate variability. Whether the user P1, P2 is in a state of stress may be determined by reading the facial expression of the user P1, P2 by the indoor camera 54.

In the present embodiment, the lower back pressing unit 76 operates the lower back air supply unit 62 when the user P1, P2 has woken up from sleep.

The spine pressing unit 78 operates the spine air supply unit 64 when a predetermined condition is satisfied. The spine pressing unit 78 of the present embodiment operates the spine air supply unit 64 when the mat body 12 is in the comfortable mode. When it is determined that the user P1, P2 is in a state of stress, the spine pressing unit 78 operates the spine air supply unit 64 to inflate the spine bladder 39.

In the present embodiment, the spine pressing unit 78 operates the spine air supply unit 64 when the user P1, P2 has woken up from sleep. The timing of pressing the lower back of the user P1, P2 by the lower back pressing unit 76 and the timing of pressing the spine of the user P1, P2 by the spine pressing unit 78 may be shifted from each other. For example, the lower back pressing unit 76 and the spine pressing unit 78 may be controlled so that the lower back bladder 38 and the spine bladder 39 alternately inflate and deflate. For example, the lower back pressing unit 76 and the spine pressing unit 78 may be controlled so that the lower back bladder 38 and the spine bladder 39 inflate and deflate at the same time.

The spine pressing unit 78 of the present embodiment operates the spine air supply unit 64 according to the breathing pattern of the user P1, P2. For example, the body pressure sensor 40 and the indoor camera 54 detect the breathing cycle of the user P1, P2. When the user P1, P2 inhales and the chest expands, the spine air supply unit 64 is operated to inflate the spine bladder 39.

### Functions

Next, functions of the embodiment will be described.

The sleeping equipment 10 according to the present embodiment is configured so that the mat body 12 is switched between the bed mode and the comfortable mode by the movable mechanism 22. In the bed mode shown in FIG. 3, the mat body 12 has a flat shape in which the middle support portion 14, the upper support portion 16, and the lower support portion 18 are continuous with each other. On the other hand, in the comfortable mode shown in FIG. 1, the upper support portion 16 and the lower support portion 18 are tilted upward with respect to the middle support portion 14. The user P1, P2 can thus change from the sleeping posture to the comfortable posture by operating the movable mechanism 22.

In the sleeping equipment 10 according to the present embodiment, the lower back bladder 38 is provided in the part of the upper support portion 16 corresponding to the lower back of the user in the comfortable mode. The lower back of the user is pressed as the lower back bladder 38 inflates. As shown in FIG. 1, in the comfortable mode, the upper support portion 16 and the lower support portion 18 are tilted upward with respect to the middle support portion 14. Accordingly, in the comfortable mode, the buttocks (hip point) are supported by the middle support portion 14 regardless of the physique of the user. That is, although the user P1 and the user P2 have different physiques, the position of the lower back falls within a certain range. Accordingly, the lower back of the user P1, P2 can be pressed by operating the lower back air supply unit 62 in the comfortable mode by the function of the lower back pressing unit 76. As a result, the sleeping equipment 10 according to the present embodiment can effectively exert the stretching effect regardless of the physique of the user.

In the sleeping equipment 10 according to the present embodiment, the chest of the user P1, P2 can be expanded by pressing the spine of the user P1, P2 with the spine pressing unit 78. This allows the user P1, P2 to take in a large amount of air, and breathing can thus be facilitated. In particular, breathing of the user can be effectively facilitated by operating the spine air supply unit 64 according to the breathing pattern of the user P1, P2 as in the present embodiment.

In the sleeping equipment 10 according to the present embodiment, when the user P1, P2 is in a state of stress, the lower back air supply unit 62 and the spine air supply unit 64 are operated to stretch the body of the user P1, P2. The stress can thus be reduced.

In the sleeping equipment 10 according to the present embodiment, the lower back air supply unit 62 and the spine air supply unit 64 are operated when the user P1, P2 have woken up. This allows the user P1, P2 to take a large amount of air into his or her body when he or she wakes up from sleep. As a result, the user P1, P2 can wake up comfortably.

In the sleeping equipment 10 according to the present embodiment, air is supplied from the lower back air supply unit 62 into the lower back bladder 38 to inflate the lower back bladder 38, thereby pressing the lower back of the user P1, P2. The lower back of the user can thus be pressed with a simple structure. Moreover, reduction in weight can be achieved as compared to a structure that mechanically presses the lower back.

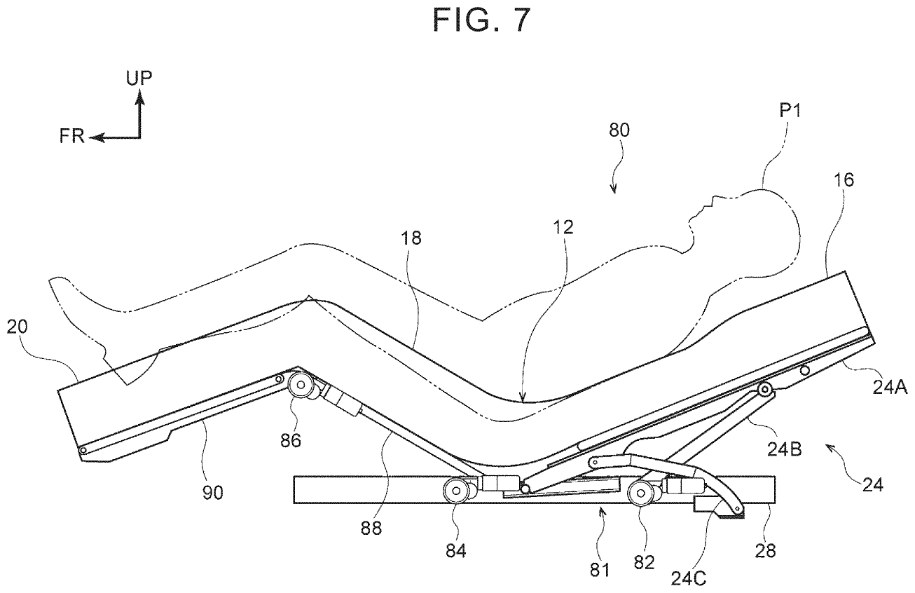

In the above embodiment, as shown in FIG. 1, the mat body 12 is deformed by the movable mechanism 22 including the link mechanism 56 and the lifting bladder 26. However, the present disclosure is not limited to this. The structure of a modification shown in FIG. 7 may be used.

### Modification

As shown in FIG. 7, in sleeping equipment 80 according to the modification, a movable mechanism 81 includes the link mechanism 24, a lower frame 88, a leg frame 90, a first recliner 82, a second recliner 84, and a third recliner 86. The first recliner 82 is provided at the connection portion between the second link 24B and the support base 28 in the link mechanism 24. The second link 24B is configured to rotate about its one end when the first recliner 82 is operated.

The lower frame 88 is provided on the lower surface side of the lower support portion 18 of the mat body 12. The lower frame 88 extends along the lower support portion 18 and supports the lower support portion 18.

One end of the lower frame 88 is rotatably connected to the support base 28, and the second recliner 84 is provided at the connection portion between the lower frame 88 and the support base 28. The lower frame 88 is configured to rotate about the one end when the second recliner 84 is operated.

The leg frame 90 is provided in front of the lower support portion 18. The leg frame 90 extends along the leg support portion 20 and supports the leg support portion 20. The lower frame 88 and the leg frame 90 are rotatably connected to each other, and the third recliner 86 is provided at the connection portion between the lower frame 88 and the leg frame 90. The leg frame 90 is configured to rotate with respect to the lower frame 88 when the third recliner 86 is operated.

As described above, in the sleeping equipment 80 according to the modification, the mat body 12 can be switched between the comfortable mode and the bed mode by operating the first recliner 82, the second recliner 84, and the third recliner 86. Since the same parts can be used as the first recliner 82, the second recliner 84, and the third recliner 86, the number of types of parts can be reduced.

Although the sleeping equipment 10 according to the embodiment is described above, it should be understood that the present disclosure can be carried out in various modes without departing from the scope of the disclosure. For example, in the above embodiment, the mat body 12 is composed of the middle support portion 14, the upper support portion 16, the lower support portion 18, and the leg support portion 20 that are continuous with each other. However, the present disclosure is not limited to this. That is, a portion that supports the buttocks of the user P1, P2 and a portion that supports the back and head of the user P1, P2 may be separate parts that are connected together.

In the above embodiment, as shown in FIG. 4, the support bladder 34 is disposed inside the mat body 12. However, the present disclosure is not limited to this. For example, the sleeping equipment 10 may not include the support bladder 34. Even in this case, the lower back and back of the user P1, P2 can be stretched by inflating the lower back bladder 38 and the spine bladder 39.

In the above embodiment, the mat body 12 is configured to be switched between the comfortable mode and the bed mode by the movable mechanism 22. However, the present disclosure is not limited to this. For example, the mat body 12 may be configured to be switched among three modes, namely the comfortable mode, the bed mode, and the chair mode, by the movable mechanism 22. In this case, by rotating the rotating frame 32 downward from the comfortable mode shown in FIG. 1 and deflating the lifting bladder 26 and the leg bladder 30, the lower support portion 18 becomes horizontal and the leg support portion 20 extends downward from the lower support portion 18. By operating the link mechanism 24 to cause the upper support portion 16 to stand, the mat body 12 turns into the shape of a chair. Since the mat body 12 is thus configured to switch among the three modes, namely the comfortable mode, the bed mode, and the chair mode, the sleeping equipment 10 can be widely used such as being mounted on a vehicle.

Although the configuration including the spine bladder 39 is described in the above embodiment, the present disclosure is not limited to this. For example, the sleeping equipment 10 may include only the lower back bladder 38 and may not include the spine bladder 39. In this case, the thickness of the mat body 12 can be reduced as compared to the structure including the spine bladder 39.

In the above embodiment, the lower back of the user P1, P2 is pressed by inflating the lower back bladder 38. However, the present disclosure is not limited to this. For example, the lower back of the user P1, P2 may be mechanically pressed using a cylinder etc.

What is claimed is:

1. Sleeping equipment, comprising:
a mat body including a middle support portion configured to support buttocks of a user, an upper support portion configured to support a back and head of the user, and a lower support portion configured to support thighs of the user;
a movable mechanism configured to switch the mat body between a bed mode and a comfortable mode, the bed mode being a mode in which the mat body has a flat shape with the middle support portion, the upper support portion, and the lower support portion being continuous with each other, and the comfortable mode being a mode in which the upper support portion and the lower support portion are tilted upward with respect to the middle support portion; and
a lower back pressing mechanism provided in a part of the upper support portion corresponding to a lower back of the user in the comfortable mode, the lower back pressing mechanism being configured to bulge out toward the user in the comfortable mode.

2. The sleeping equipment according to claim 1, further comprising a spine pressing mechanism provided in a middle in a lateral direction of the upper support portion and configured to bulge out toward the user.

3. The sleeping equipment according to claim 2, further comprising a biological sensor configured to detect biological information of the user, wherein the spine pressing mechanism is configured to operate according to a breathing pattern of the user based on the biological information from the biological sensor.

4. The sleeping equipment according to claim 3, wherein the lower back pressing mechanism and the spine pressing mechanism are configured to operate when determination that the user is in a state of stress is made based on the biological information from the biological sensor.

5. The sleeping equipment according to claim 3, wherein the lower back pressing mechanism and the spine pressing mechanism are configured to operate when determination that the user has woken up from sleep is made based on the biological information from the biological sensor.

6. The sleeping equipment according to claim 1, wherein the lower back pressing mechanism includes a lower back bladder disposed inside the upper support portion, and an air supply unit configured to supply air into the lower back bladder.
